(19) United States
(12) Patent Application Publication
(10) Pub. No.: US 2005/0278730 A1
(43) Pub. Date: Dec. 15, 2005

(54) Disc cartridge

(76) Inventor: Takashi Ohgi, Miyagi (JP)

Correspondence Address: William S. Frommer, Esq.;FROMMER LAWRENCE & HAUG LLP, 745 Fifth Avenue, New York, NY, 10151, US

(21) Appl. No.: 11/125,608

(22) Filed: May 9, 2005

(30) Foreign Application Priority Data
May 10, 2004 (JP) 2004-140475

(51) Int. Cl. G11B 23/03

(52) U.S. Cl. 720/728

(57) ABSTRACT

A disc cartridge is formed by reliably bonding the upper and lower halves if the disc cartridge is downsized in order to adapt itself to a downsized disc. The disc cartridge comprises paired upper and lower halves for forming cartridge main body that contains an optical disc. Outer peripheral wall forming walls are arranged along the outer peripheries of the upper and lower halves and containing section forming walls are arranged on the inner surfaces of the upper and lower halves that are located vis-à-vis and matched with each other to produce a disc containing section. The lower half is provided with a disc driving aperture for receiving a rotary drive means and a recording and/or reproduction aperture. The cartridge main body is integrally formed by matching the outer peripheral wall forming walls formed along the outer peripheral edges of the upper and lower halves and welding them together and also by welding parts of the upper and lower halves located closer to the containing section forming walls relative to the outer peripheral edges of the upper and lower halves and close to one of the opposite lateral sides of the recording and/or reproduction aperture in the insides thereof.

### CROSS-REFERENCE TO RELATED APPLICATIONS

The present invention contains subject matter related to Japanese Patent Application JP 2004-140475 filed in the Japanese Patent Office on May 10, 2004, the entire contents of which being incorporated herein by reference.

### BACKGROUND OF THE INVENTION

1. Field of the Invention

This invention relates to a disc cartridge containing a disc such as an optical disc.

2. Description of the Related Art

Disc cartridges rotatably containing a disc such as an optical disc and adapted to be mounted in a recording and/or reproduction apparatus with the disc contained therein are being widely used. Such disc cartridges provide advantages including protection of the disc contained therein and ease of being mounted in and dismounted from a recording and/or reproduction apparatus because of the fact that a disc is contained in the cartridge main body.

In order for a disc cartridge of the type under consideration to be mounted in and dismounted from a recording and/or reproduction apparatus with a disc contained in the cartridge main body, the cartridge main body is provided with a disc driving aperture for exposing the turn table of the disc rotary drive mechanism for rotating and operating the disc and a recording and/or reproduction aperture for partly exposing the signal recording region of the disc between the inner and outer peripheries thereof.

The disc cartridge main body of the disc cartridge for containing the disc is normally formed by integrally combining upper and lower halves of the main body that are prepared by molding synthetic resin.

The lower half of the disc cartridge of the cartridge main body is provided with a disc driving aperture and a recording and/or reproduction aperture. Additionally, the lower half of the disc cartridge of the cartridge main body is also provided with an aligning hole to be engaged with an aligning pin for aligning the disc cartridge with the disc recording and/or reproduction apparatus. As a matter of course, the aligning hole is arranged at the side thereof located close to the disc recording and/or reproduction apparatus. Both the upper and lower halves are provided along the outer periphery thereof with respective outer peripheral wall forming walls that produce an outer peripheral wall of the cartridge main body when put together. Additionally, arc-shaped containing section forming walls are arranged continuously or discontinuously at the inner peripheral sides of the respective outer peripheral wall forming walls. They produce a disc containing section when put together.

When the upper and lower halves are combined to produce a cartridge main body, the upper half has to be accurately aligned with the lower half that is provided with the disc driving aperture and the aligning hole for matching and then the two halves have to be bonded firmly. In other words, if the upper and lower halves are mismatched and bonded improperly, the matching parts of the containing section forming walls and those of the outer peripheral wall forming walls are displaced from each other. If the matching parts of the containing section forming walls are displaced from each other, a step can be produced in the disc containing section to consequently damage the disc contained in the disc containing section. If, on the other hand, the matching parts of the outer peripheral wall forming walls are displaced from each other, the appearance of the disc cartridge can be damaged and it may not possible to smoothly mount the disc cartridge in and dismount it from the disc recording and/or reproduction apparatus.

In an attempt to avoid the above-identified problem, Japanese Patent Application Laid-Open Publication No. 2000-26054 (Patent Document 1) proposes a disc cartridge designed to align upper and lower halves before bonding then together.

Meanwhile, discs that have been proposed in recent years are downsized and at the same time adapted to record information extremely highly densely. Accordingly, disc cartridges for containing such a small disc are also downsized.

One of the problems that need to be solved for downsized disc cartridges designed to contain a downsized disc is that the positions for the upper and lower halves to be provided with binding means for matching the halves and bonding them together are quite limited. As a result, it is often very difficult to very accurately align the upper and lower halves and bonding them together. If it is difficult to very accurately align the upper and lower halves and bonding them together, it is then difficult to obtain a high precision disc cartridge. Additionally, it is difficult to reliably bind the upper and lower halves. Then, it is difficult to reliably protect the disc contained in the disc cartridge formed by such upper and lower halves.

Additionally, in the case of a disc cartridge provided with a shutter member for opening and closing the recording and/or reproduction aperture, the shutter member partly abuts the upper half and/or the lower half to make it difficult to reliably move and open or close the aperture if the upper and lower halves are bonded reliably.

### SUMMARY OF THE INVENTION

In view of the above-identified circumstances, it is desirable to provide a disc cartridge that is formed by reliably bonding the upper and lower halves if the disc cartridge is downsized in order to adapt itself to a downsized disc.

It is also desirable to provide a disc cartridge that is formed by reliably bonding the upper and lower halves and can reliably protect the disc contained in it.

It is also desirable to provide a disc cartridge that is formed by reliably bonding the upper and lower halves and with a shutter member that can be moved reliably to open and close the recording and/or reproduction aperture arranged in the cartridge main body thereof.

It is also desirable to provide a disc cartridge having a cartridge main body whose end to be used for inserting itself into a recording and/or reproduction apparatus shows a semicircular arc-shaped profile that corresponds to the outer profile of the disc contained in it.

According to the present invention, the above objects of the invention are achieved by providing a disc cartridge comprising: a disc; and a cartridge main body formed by matching paired upper and lower halves made of synthetic resin and boding them, the cartridge main body having a semicircular arc-shaped section formed at the insertion end side thereof to be used for inserting itself into a recording and/or reproduction apparatus with its center located at the center of the disc contained therein, the rear side of the cartridge main body located opposite to the insertion end side being formed as a curved section having a diameter greater than that of the insertion end side; an outer peripheral wall being formed around the outer periphery of the cartridge main body by matching outer peripheral wall forming walls formed along the outer peripheral edges of the upper and lower halves and bonding them to each other; a recording medium containing section for rotatably containing the disc being formed in the inside of the cartridge main body by means of parts of the outer walls located at the side of the arc-shaped section and containing section forming walls of the upper and lower halves formed at the inside of parts of the outer peripheral wall forming walls constituting the rear side part of the outer peripheral wall of the cartridge main body so as to be matched with each other; a disc driving aperture being formed in the lower half of the cartridge main body to expose at least part of disc rotary drive mechanism for rotating and operating the disc, and a recording and/or reproduction aperture being formed to expose part of the disc across the outer and inner peripheries thereof by cutting out the outer peripheral edge of the cartridge main body. The cartridge main body is integrally formed by matching the outer peripheral wall forming walls formed along the outer peripheral edges of the upper and lower halves with each other and bonding them together and also welding parts of the upper and lower halves located closer to the containing section forming walls relative to the outer peripheral edges of the upper and lower halves and close to one of the opposite lateral sides of the recording and/or reproduction aperture in the insides thereof.

Preferably, in a disc cartridge according to the invention, parts of the matching surfaces of the containing section forming walls of the upper and lower halves to be matched with each other located close to one of the opposite lateral sides of the recording and/or reproduction aperture are welded to each other and part of the regions surrounded by the outer peripheral forming walls and the containing section forming walls of the upper and lower halves are welded to each other.

Preferably, in a disc cartridge to according to the invention, a shutter member is movably fitted to the cartridge main body to open and close the recording and/or reproduction aperture and the upper and lower halves are welded to each other in a region located at one of the opposite lateral sides of the recording and/or reproduction aperture where the shutter member is driven to move.

Thus, in a disc cartridge according to the present invention, the outer peripheral forming walls formed along the outer peripheral edges of the upper and lower halves of the cartridge main body are matched with and welded to each other and parts of the upper and lower halves located closer to the containing section forming walls relative to the outer peripheral edges of the upper and lower halves and close to one of the opposite lateral sides of the recording and/or reproduction aperture in the insides thereof are bonded to each other. As a result, the upper and lower halves are firmly and reliably bonded together near the recording and/or reproduction aperture.

Additionally, since the containing section forming walls of the upper and lower halves are matched with and welded to each other in a disc cartridge according to the invention, the recording medium containing section can be formed accurately to reliably protect the disc contained therein.

Still additionally, the upper and lower halves of a disc cartridge according to the invention are welded to each other in a region where the shutter member is driven to move at one of the opposite lateral sides of the recording and/or reproduction aperture so that the upper and lower halves are reliably bonded to each other in the region where the shutter member is driven to move and hence the shutter member can stably and reliably move.

### BRIEF DESCRIPTION OF THE DRAWINGS

FIG. 1 is a schematic perspective view of an embodiment of disc cartridge according to the invention as viewed from the side of the upper half thereof;

FIG. 2 is a schematic perspective view of the embodiment of disc cartridge of FIG. 1 as viewed from the side of the lower half thereof;

FIG. 3 is a schematic plan view of the embodiment of disc cartridge of FIG. 1 as viewed from the side of the lower half thereof;

FIG. 4 is a schematic plan view of the lower half of the cartridge main body of the embodiment of FIG. 1, showing the outer surface thereof;

FIG. 5 is a schematic plan view of the lower half of the disc cartridge of FIG. 1, showing the inner surface thereof;

FIG. 6 is a schematic plan view of the upper half of the disc cartridge of FIG. 1, showing the inner surface thereof;

FIG. 7 is a schematic cross sectional partial view of the upper and lower halves of the embodiment of FIG. 1, where the outer peripheral wall forming walls of the upper and lower halves and hence the upper and lower halves are matched with each other;

FIG. 8 is a schematic cross sectional partial view of the upper and lower halves of the embodiment of FIG. 1, where the outer peripheral wall forming walls and the containing section forming walls of the upper and lower halves and hence the upper and lower halves are matched with each other;

FIG. 9 is a schematic cross sectional partial view of the upper and lower halves of the embodiment of FIG. 1, where the outer peripheral wall forming walls of the upper and lower halves are matched with each other and welded for integration;

FIG. 10 is a schematic cross sectional partial view of the upper and lower halves of the embodiment of FIG. 1, where the outer peripheral wall forming walls of the upper and lower halves are matched with and welded to each other and the containing section forming walls of the upper and lower halves are matched with each other;

FIG. 11 is a schematic cross sectional view of the lower half of the embodiment of FIG. 1 taken along line A-A in FIG. 5;

FIG. 12 is a schematic cross sectional view of the upper half of the embodiment of FIG. 1 taken along line B-B in FIG. 6;

FIG. 13 is a schematic cross sectional view of the upper and lower halves of the embodiment of FIG. 1 in a state where they are matched with each other;

FIG. 14 is a schematic plan view of the embodiment of FIG. 1, showing the parts thereof where the upper and lower halves are matched with and bonded to each other;

FIG. 15 is an enlarged schematic partial plan view of the upper and lower halves of the embodiment of FIG. 1, showing the engaging projections and the engaging recesses formed at the front end of the respective outer peripheral wall forming walls of the upper and lower halves;

FIG. 16 is a schematic perspective view of another embodiment of disc cartridge according to the invention as viewed from the side of the upper half thereof; and

FIG. 17 is a schematic perspective view of the embodiment of disc cartridge of FIG. 16 as viewed from the side of the lower half thereof.

### DETAILED DESCRIPTION OF THE PREFERRED EMBODIMENTS

Now, a disc cartridge according to the invention will be described in greater detail by referring to the accompanying drawings that illustrate a preferred embodiment.

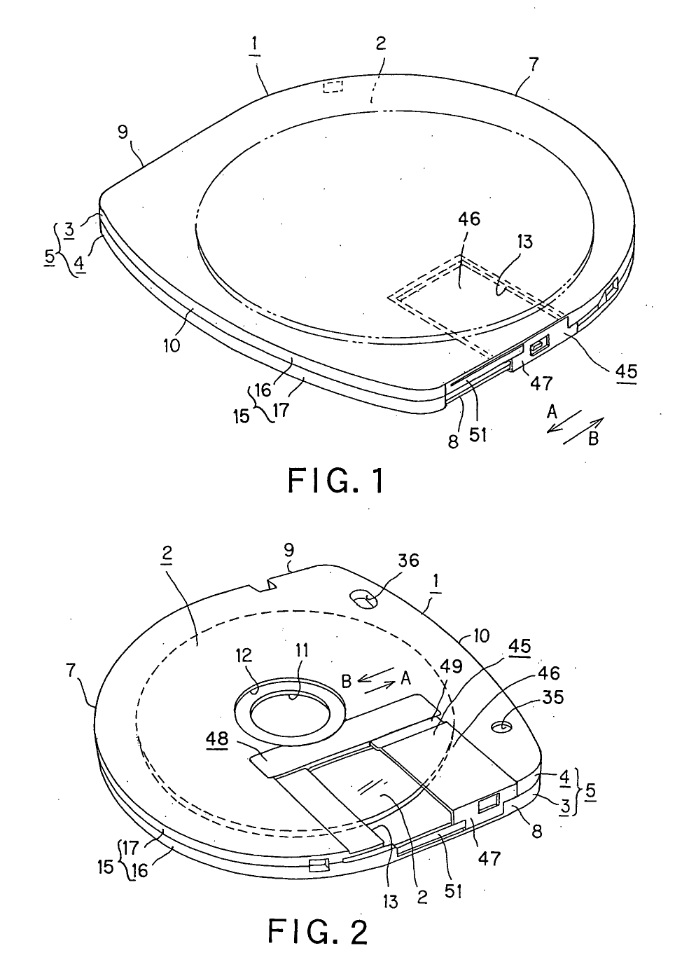

A disc cartridge 1 according to the invention contains a disc, which may typically be an optical disc 2. As shown in FIGS. 1 and 2, it comprises a cartridge main body 5 formed by matching and bonding paired upper and lower halves 3, 4. The optical disc 2 is rotatably contained in the cartridge main body 5.

The embodiment of disc cartridge 1 according to the invention is designed to contain an optical disc 2 on which program data and video data for playing a television game are recorded and which is very compact. The disc cartridge 1 typically contains an optical disc 2 having a diameter as small as 60 mm. Thus, the disc cartridge 1 is so small that it can be hidden in a palm.

As shown in FIGS. 1 through 3, the cartridge main body 5 of the disc cartridge 1 has an arc-shaped section 7 at the front side thereof that operates as insertion end to be used for inserting itself into a recording and/or reproduction apparatus. As shown in FIG. 2, the arc-shaped section 7 shows a semicircular arc-shaped profile that has a constant radius R₁ with its center Po located at the center of the optical disc 2 contained in disc containing section 6 of the cartridge main body 5. In other words, the arc-shaped section 7 shows a semicircular profile that corresponds to a half of the optical disc 2 contained in the cartridge main body 5.

The lateral sides 8, 9 that extend continuously from the arc-shaped section 7 of the cartridge main body 5 are arranged in parallel with each other and the rear side that is located opposite to the arc-shaped section 7 forms a curved section 10 that is mildly and continuously curved. In short, the curved section 10 is formed at the rear side of the cartridge main body 5 and has a radius greater than that of the semicircular arc-shaped section 7, or a curvature smaller than that of the arc-shaped section 7, which is formed at the front side of the cartridge main body 5.

Since the disc cartridge 1 according to the invention has an arc-shaped section 7 at the front side, or the insertion end side, and the arc-shaped section 7 is curved to a large extent as compared with the opposite side, it can be easily introduced into a slot-in type disc recording and/or reproduction apparatus by way of the cartridge lead-in/lead-out port of the apparatus. Particularly, in the case of a compact disc cartridge 1 that can be hidden in a palm, the insertion end side of the disc cartridge 1 can be identified simply by touching it with a finger so that the user can put the disc cartridge 1 into a disc recording and/or reproduction apparatus properly without fail. Additionally, as pointed out hereinafter, the disc cartridge 1 can be introduced particularly easily and reliably in a slot-in type disc recording and/or reproduction apparatus.

Since the disc cartridge 1 according to the invention has an arc-shaped section 7 at the front end and a curved section 10 at the rear end, or at the side opposite to the arc-shaped section 7, it can be remarkably downsized relative to the optical disc 2 it contains.

Now, the upper and lower halves 3, 4 that are matched and bonded to each other to produce the cartridge main body 5 will be described in detail.

The upper and lower halves 3, 4 are typically made of a synthetic resin material such as polycarbonate resin or ABS resin and formed by molding.

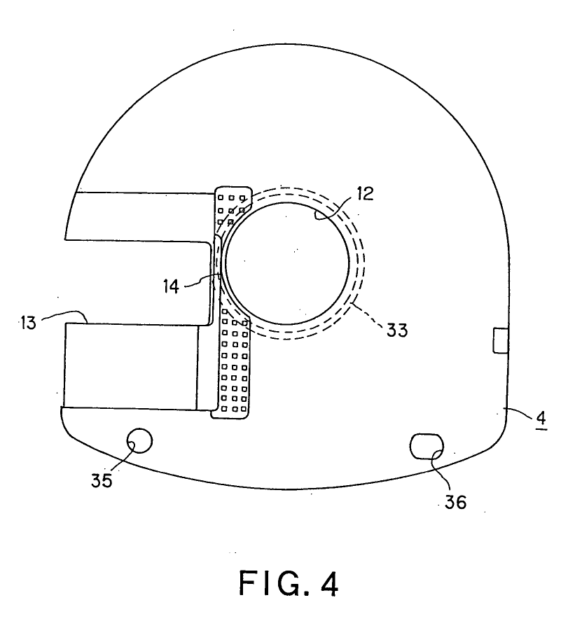

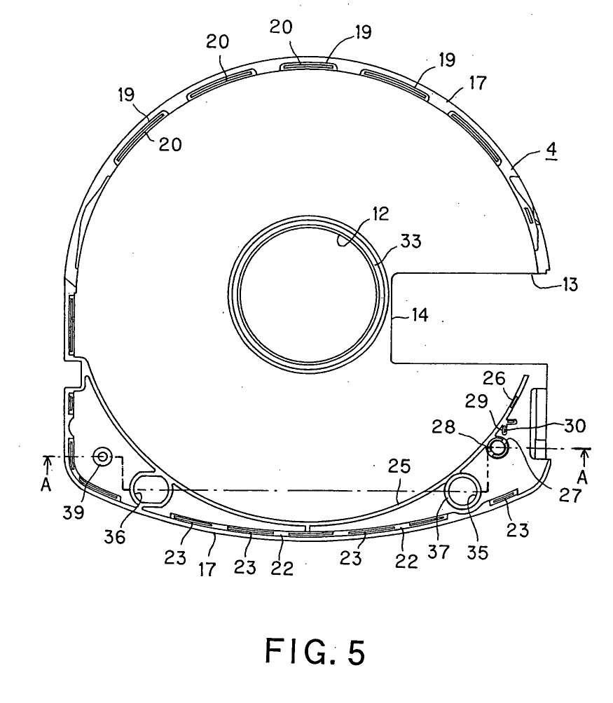

As shown in FIGS. 4 and 5, a circular central disc driving aperture 12 for exposing the center hole 11 running through the center the optical disc 2 and its peripheral edge is formed in a central part of the lower half 4 that produces the lower surface of the cartridge main body 5. The central disc driving aperture 12 is adapted to receive a turn table that is part of the disc rotary drive mechanism of the disc recording and/or reproduction apparatus into which the disc cartridge 1 is introduced. The optical disc 2 contained in the disc cartridge 1 is mounted on the turn table that comes into the cartridge main body 5 through the disc driving aperture 12 and driven to rotate.

As shown in FIGS. 2 through 5, a head receiving aperture 13 is also formed in the lower half 4 so as to operate as recording and/or reproduction aperture. The head receiving aperture 13 is located at one of the lateral sides, or the lateral side 8, of the cartridge main body 5. More specifically, it has a rectangular contour that extends from a position close to the disc driving aperture 12 to the lateral side 8. In other words, the head receiving aperture 13 shows a rectangular contour that is large enough to partly expose the signal recording region of the optical disc 2 contained in the cartridge main body 5 between the inner and outer peripheries thereof. As shown in FIG. 4, the head receiving aperture 13 is so formed as to open the outer peripheral edge of the cartridge main body 5 at the lateral side 8. Because the head receiving aperture 13 is so formed as to open the outer peripheral edge of the cartridge main body 5, the scanning region of the optical head of the disc recording and/or reproduction apparatus is extended to the outermost periphery of the optical disc 2 to enlarge the signal recording region of the optical disc 2 and hence increase the recording capacity of the optical disc 2. Additionally, since the head receiving aperture 13 is discontinued from the disc driving aperture 12 by a link section 14 arranged between itself and the disc driving aperture 12, the mechanical strength of the lower half 4 is secured.

The upper half 3 is matched with and bonded to the lower half 4 to produce the upper surface of the cartridge main body 5 that is flat particularly at the inner surface side thereof and does not have any aperture as shown in FIG. 1. In other words, it simply faces the optical disc 2.

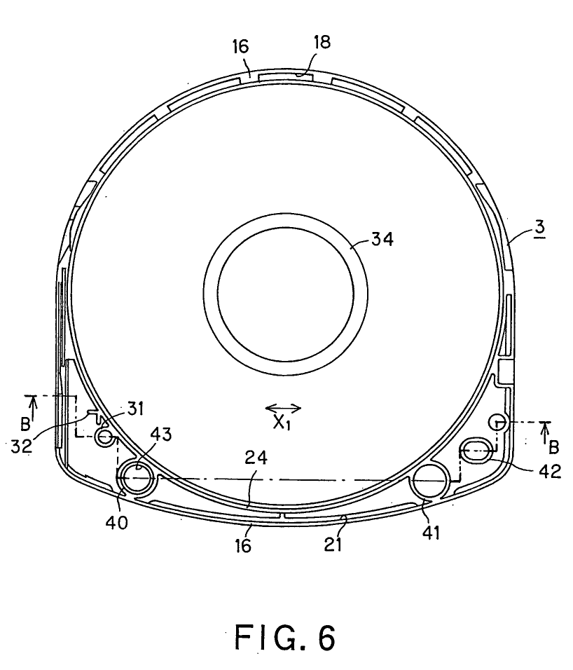

Outer peripheral wall forming walls 16, 17 rise respectively from the outer peripheries of inner surfaces of the upper and lower halves 3, 4 toward each other to form the outer peripheral wall 15 of the cartridge main body 4. As shown in FIGS. 5 and 6, the outer peripheral wall forming walls 16, 17 are formed respectively along the outer peripheral edges of the upper and lower halves 3, 4. A plurality of engaging recesses 18 and the same number of engaging projections 19 are formed respectively at the matching surface sides of the outer peripheral wall forming walls 16, 17 in the regions of the upper and lower halves 3, 4 that constitute the semicircular arc-shaped section 7 of the cartridge main body 5. More specifically, two engaging recesses 18 and two engaging projections 19 are formed transversally symmetrically in a central part of the arc-shaped section 7 where the arc-shaped section 7 outwardly projects most and two pairs of engaging recesses 18 and two pairs of engaging projections 19 are formed at each lateral side and arranged symmetrically.

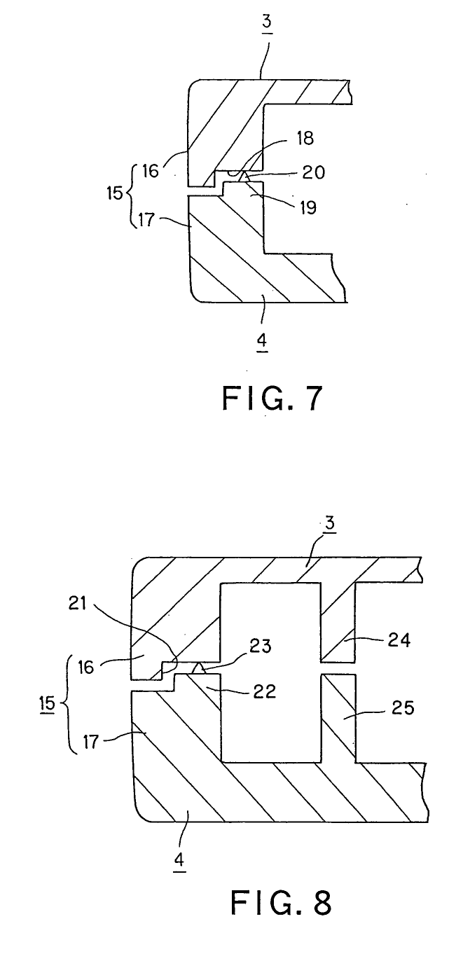

The engaging recesses 18 are formed in the upper half 3, whereas the engaging projections 19 are formed in the lower half 4. As shown in FIG. 7, the engaging recesses 18 are formed by notching the outer peripheral wall forming wall 16 of the upper half 3 from the inner peripheral surface side thereof. The engaging projections 19 are so formed as to project from the front end of the outer peripheral wall forming wall 17 of the lower half 4. As shown in FIG. 7, a welding rib 20 is formed at the front end of each of the engaging projections 19 so as to operate as welding section for bonding the upper and lower halves 3, 4.

As shown in FIG. 8, an engaging recess 21 and an engaging projection 22 are also formed respectively at the front ends of the outer peripheral wall forming walls 16, 17 in the region of the upper and lower halves 3, 4 that constitute the curved section 10 of the disc cartridge main body 5. The engaging recess 21 is formed in the upper half 3, whereas the engaging projection 22 is formed in the lower half 4. The engaging recess 21 is formed by notching the outer peripheral wall forming wall 16 of the upper half 3 from the inner peripheral surface side thereof. The engaging projection 22 is so formed as to project from the front end of the outer peripheral wall forming wall 17 of the lower half 4. As shown in FIG. 8, a plurality of welding ribs 23 are formed at the front end of the engaging projection 22 so as to operate as so many welding sections for bonding the upper and lower halves 3, 4. As shown in FIG. 5, the welding ribs 23 are formed at the front end of the engaging projection 22 at appropriate intervals.

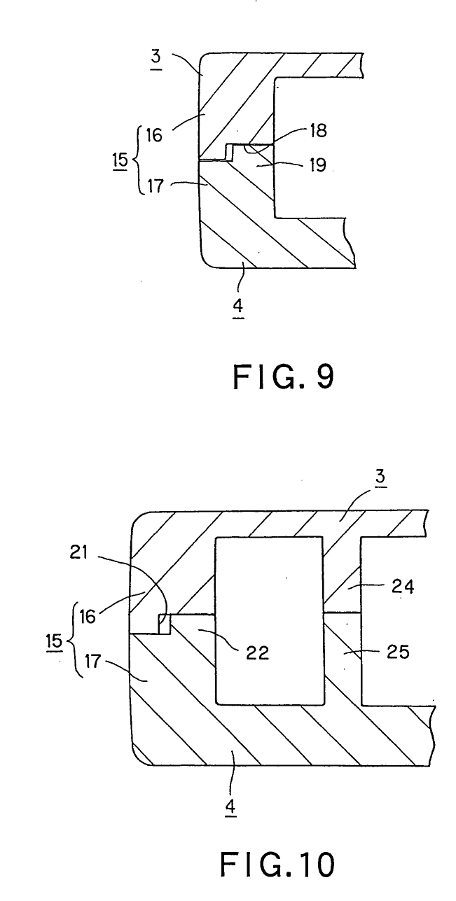

The outer peripheral wall forming walls 16, 17 are welded to each other to produce the outer peripheral wall 15 of the cartridge main body 5 as the engaging recesses 18, 21 and the corresponding engaging projections 19, 22 are matched and welded to each other by melting the welding ribs 20, 23 as shown in FIGS. 9 and 10. The outer peripheral wall forming walls 16, 17 are welded to each other by applying a ultrasonic wave to the welding ribs 20, 23 and melting them.

Containing section forming walls 24, 25 are formed respectively on the inner surface sides of the upper and lower halves 3, 4, which are located vis-à-vis relative to each other, at the rear side of the cartridge main body 5 where the curved section 10 is formed so as to be matched to produce part of a circular disc containing section 6. As shown in FIGS. 5 and 6, the containing section forming walls 24, 25 are located respectively in the inside of the parts of the outer peripheral wall forming walls 16, 17 of the outer peripheral wall 15 that constitute the curved section 10 of the cartridge main body 5 and continued from the parts of the outer peripheral wall forming walls 16, 17 that constitute the arc-shaped section 7 at the front side of the cartridge main body 5.

Thus, the disc cartridge 1 of this embodiment of the invention can be remarkably downsized relative to the optical disc 2 contained therein because the disc containing section 6 of the disc cartridge 1 is formed by utilizing part of the outer peripheral wall 15 of the cartridge main body 5.

The containing section forming walls 24, 25 for producing the disc containing section 6 and the parts of the outer peripheral wall forming walls 18, 19 that constitute the arc-shaped section 7 at the front side of the cartridge main body 5 are so arranged as to surround the outer periphery of the optical disc 2 contained in the disc containing section 6. Therefore, they clearly define the area for containing the optical disc 2 in the disc containing section 6 and also operate as disc protection walls that prevent foreign object from entering the disc containing section 6 and protect the optical disc 2 contained therein.

The upper and lower halves 3, 4 of the cartridge main body 5 of the disc cartridge 1 of this embodiment are welded to each other at parts thereof located close to the containing section forming walls 24, 25 rather than the outer peripheral edge at one of the opposite sides of the head receiving aperture 13.

More specifically, as shown in FIG. 5, a tapered welding rib 26 is formed on the surface of the containing section forming wall 25 of the lower half 4 to be matched with the containing section forming wall 24 of the upper half at a position close to one of the opposite sides of the head receiving aperture 13.

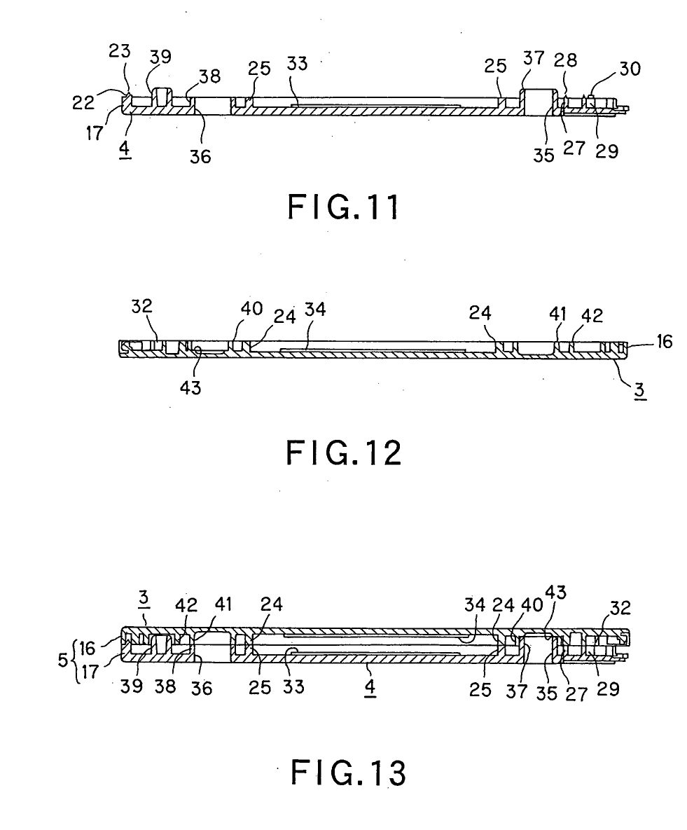

Additionally, as shown in FIGS. 5 and 11, a cylindrical binder pin 27 is formed in one of the regions defined by the containing section forming wall 25 of the lower half 4 and the outer peripheral wall forming wall 17 of the lower half 4 located at the rear side to produce the curved section 10 of the cartridge main body 5. A tapered welding rib 28 is formed at the front end surface of the binder pin 27 so as to project from it.

Additionally, an L-shaped matching piece 29 is arranged, as shown in FIGS. 5 and 11, at a position located between the welding rib 26 formed on the containing section forming wall 25 and the binder pin 27 in the region of the lower half 4 where the binder pin 27 is formed. A tapered welding rib 30 is also formed at the front end surface of the matching piece 29 so as to project from it. Additionally, since the matching piece 29 is continuous from the outer peripheral surface side of the containing section forming wall 25, it can improve the strength of the containing section forming wall 25. Meanwhile, in a compact disc cartridge 1, the elements constituting the cartridge main body 5 are required to be very thinly formed in order to downsize the cartridge per se. Therefore, the containing section forming wall 25 is formed to be very thin. However, as the matching piece 29 is formed to support the containing section forming wall 25 from the outer peripheral surface side so that the containing section forming wall 25 can be formed accurately with an improved mechanical strength. Particularly, the containing section forming wall 25 has an open end that is located vis-à-vis the head receiving aperture 13 and hence can be easily deformed by strain if it is very thin. However, it is prevented from being deformed by strain and accurately aligned and matched with the containing section forming wall 24 of the upper half 3 when it is supported by the matching piece 29.

On the other hand, as shown in FIGS. 6 and 12, a binder receiving pin 31 is formed on the upper half 3 in such a way that the front end of the binding pin 27 of the lower half 4 is brought into contact with and bonded to it when the upper half 3 is matched with the lower half 4. Additionally, also as shown in FIGS. 6 and 12, a matching binder piece 32 to be matched with and bonded to the matching piece 29 of the lower half 4 is formed on the upper half 3. Like the matching piece 29, the matching binder piece 32 is also linked to the outer peripheral surface side of the containing section forming wall 24 so that the thin containing section forming wall 25 can be formed accurately with an improved mechanical strength. Since the containing section forming wall 24 also has an open end that is located vis-à-vis the head receiving aperture 13 and hence can be easily deformed by strain if it is very thin. However, it is prevented from being deformed by strain and accurately aligned and matched with the containing section forming wall 25 of the lower half 4 when it is supported by the matching binder piece 32.

The front end surface of the containing section forming wall 24 of the upper half 3, to which the welding rib 26 formed on the containing section forming wall 25 of the lower half 4 is to be welded, is made flat.

Since the binder receiving pin 31 and the matching binder piece 32 formed on the upper half 3 are to be bonded to the binder pin 27 and the matching piece 29 of the lower half 4 respectively, they are located in one of the transversal regions defined by the containing section forming wall 24 and the rear side part of the outer peripheral wall forming wall 16, which produces the curved section 10 of the cartridge main body 5, that is found near the head receiving aperture 13.

As shown in FIGS. 5 and 11, a ring-shaped disc supporting projection 33 is formed to surround the disc driving aperture 12 on the inner surface of the lower half 4 that faces the upper half 3. Similarly, as shown in FIG. 6, a ring-shaped disc supporting projection 34 is formed on the inner surface of the upper half 3 that faces the lower half 4. The disc supporting projection 34 is arranged vis-à-vis the disc supporting projection 33 of the lower half 4. The disc supporting projections 33, 34 support the optical disc 2 contained in the disc containing section 6 at the non-signal-recording region of the inner peripheral side of the optical disc 2 and prevents the signal recording region of the optical disc from directly touching the inner surfaces of the upper and lower halves 3, 4 in order to protect the optical disc 2.

The disc supporting projection 34 formed on the upper half 3 is made to show a diameter slightly smaller than that of the disc supporting projection 33 of the lower half 4.

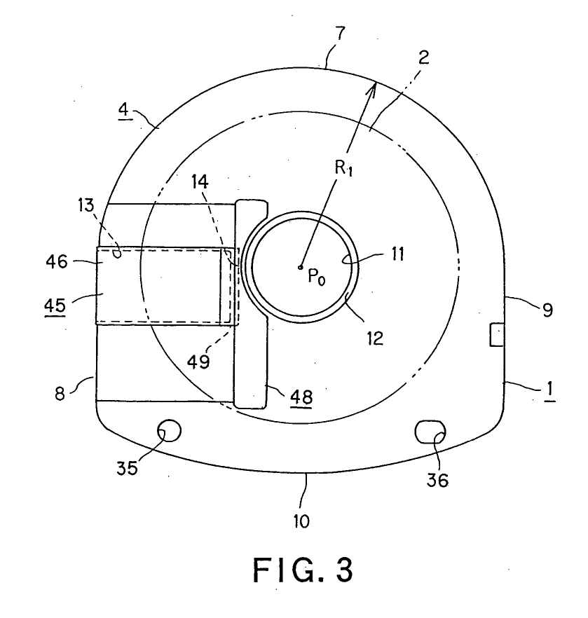

Additionally, first and second aligning holes 35, 36 are formed in the lower half 4. They are adapted to be engaged with the respective alignment pins arranged in a disc recording and/or reproduction apparatus when the disc cartridge 1 is mounted into the disc recording and/or reproduction apparatus. As shown in FIGS. 3 and 4, the alignment holes 35, 36 are arranged at the opposite ends of the rear side of cartridge main body 5 where the curved section 10 is formed. More specifically, as shown in FIG. 5, the first and second alignment holes 35, 36 are arranged in the respective transversal regions defined by the containing section forming wall 25 and the rear side part of the outer peripheral wall forming wall 16, which produces the curved section 10 of the cartridge main body 5. Note that the second alignment hole 36 is formed as an oblong hole whose major axis extends in the transversal direction that connects the lateral sides 8, 9 of the cartridge main body 5 as shown in FIGS. 3 and 4 so that the engaging position of itself and the corresponding alignment pin may be adjusted.

As shown in FIGS. 5 and 11, a cylindrical first engaging projection 37 is formed to surround the first alignment hole 35 and a cylindrical abutting projection 38 is formed to surround the second alignment hole 36 on the inner surface of the lower half 4. Additionally, a second engaging projection 39 is formed in the one of the regions defined by the containing section forming wall 25 and the outer peripheral wall forming wall 17 where the second alignment hole 36 is arranged. The second engaging projection 39 also shows a cylindrical profile.

Meanwhile, as shown in FIG. 5 the second engaging projection 39 is located at a position closer to the part of the outer peripheral wall forming wall 17 that produces the lateral side 9 of the cartridge main body 5 relative to the position where the second alignment hole 36 is formed. In other words, the second engaging projection 39 is located at a position separated further from the second alignment hole 36 relative to the first engaging projection 37 that constitutes the first alignment section.

The first engaging projection 37 constitutes the first alignment section for defining the matching position of the upper and lower halves 3, 4 and the second engaging projection 39 constitutes the second alignment section.

On the other hand, a first engaging projection receiving section 40 is formed on the inner surface of the upper half 3 so as to be engaged with the first engaging projection 37 of the lower half 4. Additionally, a cylindrical supporting projection 41 is also formed on the inner surface of the upper half 3 so as to be abutted by the abutting projection 38 of the lower half 4. Still additionally, a second engaging projection receiving section 42 is also formed on the inner surface of the upper half 3 so as to be engaged with the second engaging projection 39 of the lower half 4.

As shown in FIG. 11, the first and second engaging projections 37, 39 have a height that makes them project from the top of the outer peripheral wall forming wall 17 so that, when the outer peripheral wall forming walls 16, 17 are matched with each other and the upper and lower halves 3, 4 are bonded together, they come to be engaged respectively with the first and second engaging projection receiving sections 40, 42 that are flush with the outer peripheral wall forming wall 16.

As shown in FIG. 6, the first engaging projection receiving section 40 and the supporting projection 41 provided on the upper half 3 are arranged in the respective transversal regions defined by the containing section forming wall 24 and the rear side part of the outer peripheral wall forming wall 16, which produces the curved section 10 of the cartridge main body 5. The second engaging projection receiving section 42 is located in the region where the supporting projection 42 is arranged. As shown in FIG. 6, it is found at a position closer to the part of the outer peripheral wall forming wall 16 that produces the lateral side 9 of the cartridge main body 5 relative to the position where the supporting projection 41 is formed.

The first engaging projection 37 and the first engaging projection receiving section 40 defines the matching reference position for the upper and lower halves 3, 4 when they are engaged with each other. More specifically, the upper half 3 is bonded to the lower half 4 by referring to the first engaging projection 37 arranged on the lower half 4 that operates as engagement reference position. Therefore, as shown in FIG. 13, the first engaging projection 37 and the first engaging projection receiving section 40 have respective diameters that allow the former to be tightly fitted into the latter. In other words, the outer diameter of the cylindrical first engaging projection 37 is substantially equal to the inner diameter of the first engaging projection receiving section 40 that is engaged with the front end of the first engaging projection 37.

As shown in FIGS. 12 and 13, a stepped abutment section 43 is formed in the inside of the first engaging projection receiving section 40 so that the front end of the first engaging projection 37 abuts it. Thus, the first engaging projection 37 is engaged with the first engaging projection receiving section 40 when its front end is bought to abut the stepped abutment section 43. Since the first engaging projection receiving section 40 has the stepped abutment section 43 in the inside thereof, its base located on the flat surface of the upper half 3 can be made relatively large to show a large mechanical strength.

The second engaging projection receiving section 42 is formed to show an elliptic profile whose major axis extends in the direction indicated by arrow X₁ in FIG. 6 that connects the lateral sides 8, 9 of the cartridge main body 5 so that the position of engagement of itself and the second engaging projection 29 can be transversally adjusted when the upper and lower halves 3, 4 are matched with each other by referring to the first engaging projection 37 and the first engaging projection receiving section 40.

As shown in FIG. 11, the first and second engaging projections 37, 39 have a height that makes them project from the top of the outer peripheral wall forming wall 17 so that, when the outer peripheral wall forming walls 16, 17 are matched with each other and the upper and lower halves 3, 4 are bonded together, they come to be engaged respectively with the first and second engaging projection receiving sections 30, 32 that are flush with the outer peripheral wall forming wall 16.

When the upper and lower haves 3, 4 having the above described respective configurations are matched with and bonded to each other to produce the cartridge main body 5, the lower half 5 is positioned and supported by a positioning jig and the first energy projection 37 of the lower half 4 is brought into engagement with the first engaging projection receiving section 40 of the upper half 3, while the second engaging projection 39 of the lower half 4 is brought into engagement with the second engaging projection receiving section 42 of the upper half 3 and additionally, the plurality of engaging projections 19 of the lower half 4 are brought into engagement respectively with the corresponding engaging recesses 18 of the upper half 3 until the outer peripheral wall forming walls 16, 17 are properly matched.

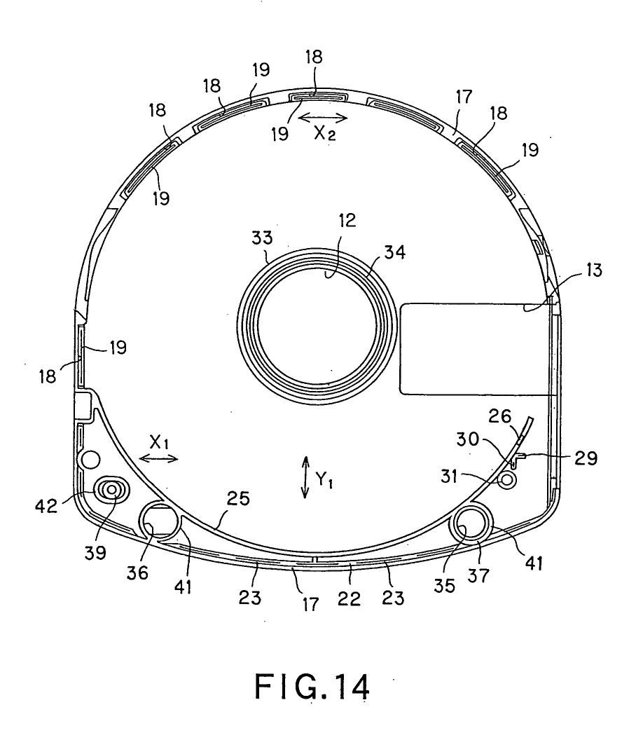

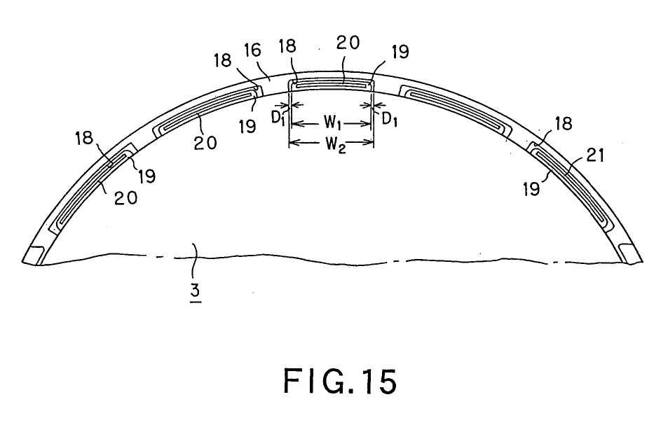

Of the engaging projections 19 of the lower half 4 that are to be brought into engagement respectively with the corresponding engaging recesses 18 of the upper half 3, the engaging projection 19 located at the middle point of the arc-shaped section 7 where the arc-shaped section 7 projects most is designed to operate as the third alignment section for aligning the upper and lower halves 3, 4 in the direction of arrow X₂ running substantially along the arc of the arc-shaped section 7 as shown in FIG. 14 when the upper and lower halves 3, 4 are matched with and bonded to each other. In other words, the engaging projection 19 that operates as the third alignment section produces little gap when it is brought into engagement with the corresponding engaging recess 18 of the upper half 3. More specifically, the engaging projection 19 that operates as the third alignment section and the corresponding engaging recess 18 to be engaged with the engaging projection 19 are formed highly accurately so as to produce only little gap D₁ when they are brought into mutual engagement. Differently stated, the engaging projection 19 and the corresponding engaging recess 18 to be engaged with it are made to have respective widths W₁, W₂ that are substantially equal to each other so that they may be tightly engaged with each other. Thus, as the engaging projection 19 that operates as the third alignment section is tightly engaged with the corresponding engaging recess 18, the upper and lower halves 3, 4 are aligned relative to each other in the direction running along the arc of the arc-shaped section 7 and bonded to each other.

It will be appreciated that the engaging projection 19 and the engaging recess 18 may be arranged conversely. In other words, the engaging projection 19 and the engaging recess 18 may be arranged respectively on the upper half 3 and on the lower half 4. Then, the engaging recess 18 of the lower half 4 operates as the third alignment section.

As pointed out above, the upper and lower halves 3, 4 are matched with each other by referring to the first engaging projection 27 as matching reference position. Then, as the second engaging projection 29 and the second engaging projection receiving section 32 are matched with each other, the upper and lower halves 3, 4 are aligned in the longitudinal direction of the cartridge main body 5 as indicated by arrow Y₁ that is orthogonal relative to the transversal direction indicated by arrow X₁ in FIG. 14. Additionally, the matching position of the arc-shaped section 7 that operates as the insertion end to be introduced into a recording and/or reproduction apparatus is defined as the paired engaging recess 18 and the engaging projection 19 that constitute the third alignment section are brought into mutual engagement.

As the upper and lower halves 3, 4 are aligned to and matched with each other, the containing section forming walls 24, 25 of the upper and lower halves 3, 4 are matched with each other, while the binder receiving pin 31 of the upper half 3 and the binder pin 27 of the lower half 4 are matched with each other and further the matching binder piece 32 of the upper half 3 and matching piece 29 of the lower half 4 are matched with each other.

The upper and lower halves 3, 4 that are aligned to and matched with each other are then firmly bonded to each other to produce an integral cartridge main body 5 as the welding ribs 23 arranged at the engaging projections 19 and the front end of the outer peripheral wall forming wall 17, the welding rib 26 formed on the containing section forming wall 25 of the lower half 4, the welding rib 28 formed at the front end surface of the binder pin 27, the welding rib 30 formed at the front end surface of the matching piece 29 are molten by applying an ultrasonic wave by means of an ultrasonic welding apparatus to bond the outer peripheral wall forming walls 16, 17, parts of the containing section forming walls 24, 25, and the matched binder pin 27 and the binder receiving pin 31 of the upper and lower halves 3, 4 relative to each other.

The welding rib 26 for bonding the containing section forming walls 24, 25, the welding rib 28 for bonding the binder pin 27 and the binder receiving pin 31 and the welding rib 30 for bonding the matching piece 29 and the matching binder piece 32 may be arranged conversely relative to the above described arrangement.

Thus, according to the invention, the positional displacement between the upper half 3 and the lower half 4 can be minimized and the cartridge main body 5 can be formed highly accurately because the upper and lower halves 3, 4 are matched with each other at three points including the first and second alignment sections arranged at the opposite ends of the rear side, or the curved section 10, of the cartridge main body 5 and the third alignment section arranged at the middle point of the arc-shaped section 7 of the front side and bonded to each other in a manner as described above. Particularly, the first to third alignment sections are located at the outer periphery side of the cartridge main body 5 at a large interval, which made the positional displacement of the upper and lower halves 3, 4 smaller to highly accurately from the cartridge main body 5. As a result, the disc cartridge 1 that comprises such a cartridge main body 5 is formed also highly accurately. Thus, it can be mounted in and dismounted from a recording and/or reproduction apparatus very smoothly and additionally shows a very appealing appearance.

Additionally, since the second engaging projection 39 that operates as the second alignment section of the lower half 4 is separated from the first engaging projection 37 by a large distance in the cartridge main body 5 of the disc cartridge 1 of this embodiment, it is possible to further minimize the positional displacement between the upper half 3 and the lower half 4. Particularly, it is possible to reduce the positional displacement of the abutting position of the abutting projection 38 arranged to surround the second aligning hole 36 between the first engaging projection 37 and the second engaging projection 39 to the corresponding cylindrical supporting projection 41 in order to make match them with each other reliably.

Still additionally, since the upper and lower halves 3, 4 of the cartridge main body 5 of the disc cartridge 1 of this embodiment are bonded to each other with minimal positional displacement, the containing section forming walls 24, 25 of the upper and lower halves 3, 4 can be matched with each other with minimal positional displacement to produce a high precision disc containing section 6. As a result, any risk of producing a projection that can damage the optical disc 2 contained in the disc containing section 6 is eliminated to reliably protect the optical disc 2.

Furthermore, the upper and lower halves 3, 4 of the cartridge main body 5 of the disc cartridge 1 of this embodiment are welded to each other at parts thereof located close to the disc containing section 6 rather than the outer peripheral edge at one of the opposite sides of the head receiving aperture 13, they can be bonded to each other near the head receiving aperture 13. Thus, the upper and lower halves 3, 4 can be reliably bonded to each other although the head receiving aperture 13 is formed by partly cutting out and opening the outer peripheral edge of the cartridge main body 5 in order to expand the signal recording region of the optical disc 2 contained therein.

Still additionally, since the upper and lower halves 3, 4 are bonded to each other at open parts of the containing section forming walls 24, 25 that are exposed to the head receiving aperture 13, the containing section forming walls 24, 25 are prevented from being deformed by strain if they are made very thin. Thus, the disc containing section 6 that is formed by matching the containing section forming walls 24, 25 with each other is prevented from being deformed to reliably protect the optical disc 2 contained in the disc containing section 6.

Particularly, the containing section forming walls 24, 25 are supported respectively by the matching piece 29 and the matching binder piece 32 so that they are prevented from being deformed by strain and can be matched with each other highly accurately. Further, it is possible to form the disc containing section 6 highly accurately by matching the containing section forming walls 24, 25 with each other.

Still additionally, since the outer peripheral wall forming walls 16, 17 for forming the outer peripheral wall 15 of the cartridge main body 5 of the disc cartridge 1 of this embodiment are also used for forming the disc containing section 6, it is possible to further downsize the disc cartridge 1.

Then, a shutter member 45 is fitted to the cartridge main body 5 that is formed in the above described manner to open and close the head receiving aperture 13 as shown in FIGS. 1, 2 and 3. The shutter member 45 is produced by punching out a thin metal plate and bending it appropriately or by molding a synthetic resin material. As shown in FIGS. 2 and 3, the shutter member 45 includes a rectangular flat shutter section 46 having dimensions that are sufficiently large for closing the head receiving aperture 13 and a cartridge supporting section 47 formed at the base end of the shutter section 46 and showing a substantially U-shaped cross section. A guide supporting section 49 is arranged at the front end of the shutter section 46 so as to be supported by shutter guide member 48 that is fitted to the cartridge main body 5.

The shutter member 45 is securely supported as the cartridge supporting section 47 supports the sliding guide section 51 formed on the upper half 3 of the cartridge main body 5 so as to be able to slide both in the direction of arrow A and in the direction of arrow B in FIGS. 1 and 2 in order to open and close the head receiving aperture 13. Since the shutter member 45 is supported by the shutter guide member 48 fitted to the cartridge main body 5, the shutter section 46 is prevented from being lifted above the cartridge main body 5 so that it can be moved stably and reliably.

Although not shown, the shutter member 45 is urged in the direction of arrow B in FIGS. 1 and 2, or in the direction of closing the head receiving aperture 13, by means of an urging member such as a torsion coil spring arranged in the cartridge main body 5 so that the head receiving aperture 13 may be reliably closed when it is stored without being mounted in a disc recording and/or reproduction apparatus.

Meanwhile, when the shutter member 45 of the disc cartridge 1 of this embodiment is moved to open the head receiving aperture 13, it is located at one of the lateral sides of the head receiving aperture 13 that is produced by cutting out the cartridge main body 5 from the outer peripheral edge thereof in an area extending inwardly from the outer peripheral edge of the cartridge main body 5 toward the disc containing section 6.

While the above described disc cartridge 1 of this embodiment is provided with a shutter member 45 for closing the head receiving aperture 13, a disc cartridge according to the invention does not necessarily comprise a shutter member and the head receiving aperture may be left open.

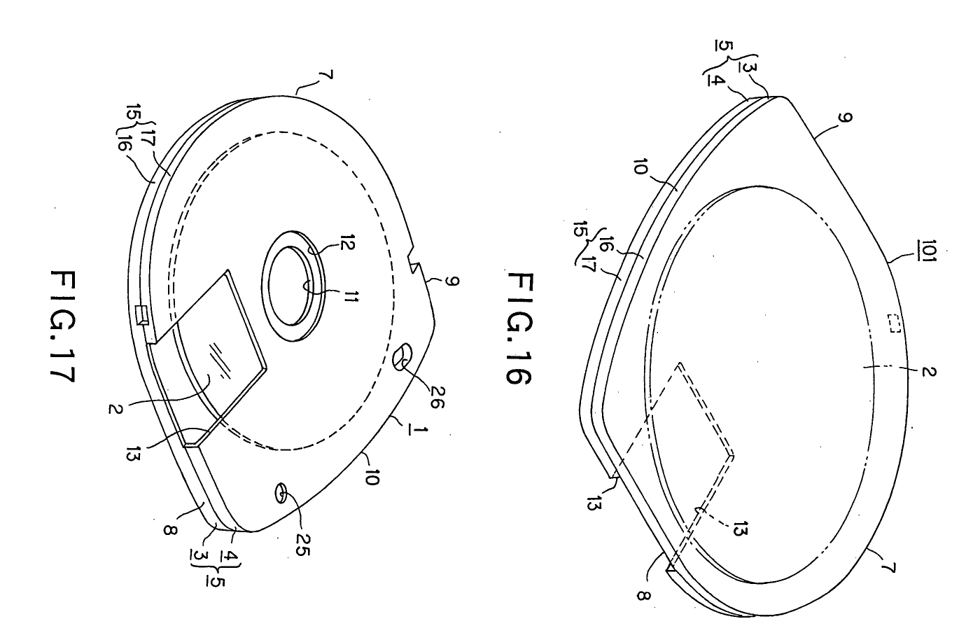

FIGS. 16 and 17 schematically illustrate an embodiment of disc cartridge 101 that does not comprise any shutter member.

Since the disc cartridge 101 of this embodiment has a configuration similar to that of the above described disc cartridge 1, the components thereof that are common to the above described disc cartridge 1 are denoted respectively by the same reference symbols and will not be described any further.

The disc cartridge 101 of this embodiment that is formed without using a shutter member also comprises a cartridge main body 5 formed by matching paired upper and lower halves 3, 4 with each other and bonding them to each other and rotatably contains an optical disc 2 in the cartridge main body 5 as in the case of the above described disc cartridge 1.

As shown in FIGS. 16 and 17, the cartridge main body 5 of this disc cartridge 101 has an arc-shaped section 7 at the front side thereof that operates as insertion end to be used for inserting itself into a recording and/or reproduction apparatus.

The lateral sides 8, 9 that extend continuously from the arc-shaped section 7 of the cartridge main body 5 are arranged in parallel with each other and the rear side that is located opposite to the arc-shaped section 7 forms a curved section 10 that is mildly and continuously curved. In short, the curved section 10 is formed at the rear side of the cartridge main body 5 and has a radius greater than that of the semicircular arc-shaped section 7, or a curvature smaller than that of the arc-shaped section 7, which is formed at the front side of the cartridge main body 5.

In this disc cartridge 101 again, as shown in FIG. 17, a circular central disc driving aperture 12 for exposing the center hole 11 running through the center of the optical disc 2 and its peripheral edge is formed in a central part of the lower half 4 that produces the lower surface of the cartridge main body 5.

As shown in FIG. 17, a head receiving aperture 13 is also formed in the lower half 4 so as to operate as recording and/or reproduction aperture. The head receiving aperture 13 is located at one of the lateral sides, or the lateral side 8, of the cartridge main body 5. More specifically, it has a rectangular contour that extends from a position close to the disc driving aperture 12 to the lateral side 8. In other words, the head receiving aperture 13 shows a rectangular contour that is large enough to partly expose the signal recording region of the optical disc 2 contained in the cartridge main body 5 between the inner and outer peripheries thereof. As shown in FIG. 17, the head receiving aperture 13 is so formed as to open the outer peripheral edge of the cartridge main body 5 at the lateral side 8. Additionally, since the head receiving aperture 13 is discontinued from the disc driving aperture 12 by a link section 14 arranged between itself and the disc driving aperture 12, the mechanical strength of the lower half 4 is secured.

Since the disc cartridge 101 of this embodiment is formed without any shutter member for opening and closing the head receiving aperture 13, the outer surface of the lower half 4 that constitutes the lower surface of the cartridge main body 5 is also made flat except the areas where the driving aperture 12 and the head receiving aperture 13 are respectively formed as shown in FIG. 17.

The upper and lower halves 3, 4 of the cartridge main body 5 of the disc cartridge 101 of this embodiment are also welded to each other at parts thereof located close to the disc containing section 6 rather than the outer peripheral edge at one of the opposite sides of the head receiving aperture 13, they can be bonded to each other near the head receiving aperture 13. Thus, the upper and lower halves 3, 4 can be reliably bonded to each other although the head receiving aperture 13 is formed by partly cutting out and opening the outer peripheral edge of the cartridge main body 5 in order to expand the signal recording region of the optical disc 2 contained therein.

Meanwhile, the head receiving aperture 13 of the disc cartridge 101 of this embodiment as illustrated in FIGS. 16 and 17 is made to have dimensions greater than the hear receiving aperture 13 of the disc cartridge 1 of the above described embodiment. More specifically, the head receiving aperture 13 of the disc cartridge 101 of this embodiment is formed by cutting an area located close to the insertion end and separated from longitudinal middle point of the center line between the insertion end and the rear end of the cartridge main body 5. This arrangement is made for the purpose of allowing the optical head for scanning the signal recording region of the optical disc 2 contained in the disc cartridge 101 with a light beam to move into the cartridge main body 5 and closer to the optical disc 2.

Since the optical head can be moved closer to the optical disc 2 in the disc cartridge 101 of this embodiment, it is possible to scan the optical disc 2 by means of an optical head comprising an objective lens that shows a large numerical aperture (NA). Then, it is possible to further increase the signal recording density of the optical disc 2 and reduce the height of the recording and/or reproduction apparatus to be used with the disc cartridge 101.

While each of the above described disc cartridges contains an optical disc in the cartridge main body as disc, the present invention is by no means limited to the use of an optical disc and the above listed advantages of the present invention are realized when a disc cartridge according to the invention contains a disc other than an optical disc, which may be a magnetic disc for example.

It should be understood by those skilled in the art that various modifications, combinations, sub-combinations and alterations may occur depending on design requirements and other factors insofar as they are within the scope of the appended claims or the equivalents thereof.

1. A disc cartridge comprising:
a disc; and
a cartridge main body formed by matching paired upper and lower halves made of synthetic resin and boding them, the cartridge main body having a semicircular arc-shaped section formed at the insertion end side thereof to be used for inserting itself into a recording and/or reproduction apparatus with its center located at the center of the disc contained therein, the rear side of the cartridge main body located opposite to the insertion end side being formed as a curved section having a diameter greater than that of the insertion end side;
an outer peripheral wall being formed around the outer peripheral of the cartridge main body by matching outer peripheral wall forming walls formed along the outer peripheral edges of the upper and lower halves and bonding them to each other;
a recording medium containing section for rotatably containing the disc being formed in the inside of the cartridge main body by means of parts of the outer walls located at the side of the arc-shaped section and containing section forming walls of the upper and lower halves formed at the inside of parts of the outer peripheral wall forming walls constituting the rear side part of the outer peripheral wall of the cartridge main body so as to be matched with each other;
a disc driving aperture being formed in the lower half of the cartridge main body to expose at least part of disc rotary drive mechanism for rotating and operating the disc, and a recording and/or reproduction aperture being formed to expose part of the disc across the outer and inner peripheries thereof by cutting out the outer peripheral edge of the cartridge main body;
the cartridge main body being integrally formed by matching the outer peripheral wall forming walls formed along the outer peripheral edges of the upper and lower halves with each other and bonding them together and also welding parts of the upper and lower halves located closer to the containing section forming walls relative to the outer peripheral edges of the upper and lower halves and close to one of the opposite lateral sides of the recording and/or reproduction aperture in the insides thereof.

2. The disc cartridge according to claim 1, wherein parts of the matching surfaces of the containing section forming walls of the upper and lower halves to be matched with each other located close to one of the opposite lateral sides of the recording and/or reproduction aperture are partly welded to each other and part of the regions surrounded by the outer peripheral forming walls and the containing section forming walls of the upper and lower halves are welded to each other.

3. The disc cartridge according to claim 1, wherein a shutter member is movably fitted to the cartridge main body to open and close the recording and/or reproduction aperture and the upper and lower halves are welded to each other in a region located at one of the opposite lateral sides of the recording and/or reproduction aperture where the shutter member is driven to move.
